(19) United States
(12) Patent Application Publication
(10) Pub. No.: US 2020/0226171 A1
(43) Pub. Date: Jul. 16, 2020

(54) AUTOMATIC CHARACTERIZATION OF MEDIA FILES

(71) Applicant: FinancialForce.com, Inc., San Francisco, CA (US)

(72) Inventor: Matthew James BYRNE, Harrogate (GB)

(21) Appl. No.: 16/249,136

(22) Filed: Jan. 16, 2019

(51) Int. Cl. G06F 16/487; G06K 9/00; G06K 9/62; G06K 9/32; G06F 16/23; G06F 16/41

(52) U.S. Cl. CPC G06F 16/487; G06K 9/0063; G06K 9/6201; G06K 2209/01; G06K 9/3258; G06F 16/2379; G06F 16/41; G06K 9/6267

(57) ABSTRACT

Introduced here are systems to automatically characterize media data into a record of a database. A database server may receive a first media data. The database server can identify meta data characteristics from metadata included within the first media data and media data characteristics indicating features of the first media data. The first metadata characteristics may be inspected to determine whether they match a first classification identified with a metadata confidence level that exceeds a threshold metadata confidence level. The first media data characteristics may be inspected to determine whether they match a second classification with a media data confidence level that exceeds a threshold media data confidence level. The first media data may be associated with a first record based on at least one of the first metadata characteristics matching the first classification and the first media data characteristics matching the second classification.

### TECHNICAL FIELD

Various embodiments concern databases and more particularly, concern characterizing media files and updating a database to include the media files.

### BACKGROUND

Databases maintain and access sets of organized data. Computing device(s) (e.g., computers, servers, etc.) may store and/or access a database. To organize data within a database, sets of data are generally sorted (or “characterized”) into various categories within the database. Examples of categories may include a folder, table, entry, record, etc. A category within the database may include subsets of data within the database. All data associated with a category of a database may include a common characteristic. For example, a database maintained by a corporation may include a category for each employee of the corporation, where each record includes data (documents, audio, etc.) associated with the employee.

Databases may include data of various types. Examples of such types of data may include text files, spreadsheets, media, etc. Upon receipt of data, the database may store the data and sort or assign the data into a category of the database. An individual (e.g., an administrator of the database) may inspect the received data and associate the data with a category within the database. When data is sorted or characterized with a category within a database, the data may be identifiable and accessible upon a query of the database.

### SUMMARY

Some embodiments of the present disclosure concern different techniques for automatically characterizing media data in a database. A computing device may receive a stream of data from a mobile field device and identify a first media data from the stream of data. The computing device may identify metadata included within the first media data that represents information relating to the mobile field device at a time of generating the first media data. The computing device identify media data characteristics of the first media data indicating features of the first media data. The metadata characteristics and the media data characteristics may be matched with classifications identified by a first record in a database when the characteristics match a classification with a confidence level that exceeds a threshold confidence level. Based on this characterization, the computing device may associate or characterize the first media data to the first record in the database.

Some embodiment of the present disclosure concern a computing device with a memory that includes instructions for updating a database, causing a processor to identify metadata and media data characteristics of a received media data. The computing device may determine that at least one of the first metadata characteristics and the first media data characteristics match a classification characteristic identified by a first record in a database with a confidence level exceeding a threshold confidence level. Based on this determinization, the computing device may associate the first media data to the first record based on at least one of the metadata characteristics and the media data characteristics of the first media data matching the classification characteristic.

Some embodiments of the present disclosure concern methods performed by a computing device to update a database. The method may include receiving a first media data and identifying first metadata characteristics identifying information relating to a mobile field device at a time of generating the first media data. The method may include determining that the first metadata characteristics match a first classification identified by a first record in a database with a metadata confidence level that exceeds a threshold metadata confidence level. The method may include identifying first media data characteristics indicating features of the media data. The method may include determining that the first media data characteristics match a second classification identified by the first record in the database with a media data confidence level that exceeds a threshold media data confidence level. The method may include associating the first media data to the first record based on at least one of the first metadata characteristics matching the first classification and the first media data characteristics matching the second classification.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Various features and characteristics of the technology will become more apparent to those skilled in the art from a study of the Detailed Description in conjunction with the drawings. Embodiments of the technology are illustrated by way of example and not limitation in the drawings, in which like references may indicate similar elements.

FIG. 1 illustrates a network environment including a field device and a database server, consistent with various embodiments.

FIG. 2 illustrates a network environment including multiple field devices and a database server, consistent with various embodiments.

FIG. 3 depicts an illustration of media data transmitted by the field device to the database server, consistent with various embodiments.

FIG. 4 depicts an illustration of a flow process to characterize media data and update a database, consistent with various embodiments.

FIG. 5 depicts a block diagram illustrating a flow process to update a database, consistent with various embodiments.

FIG. 6 depicts a block diagram illustrating a method to update a database, consistent with various embodiments.

FIG. 7 is a block diagram illustrating an example of a processing system in which at least some operations described herein can be implemented.

The drawings depict various embodiments for the purpose of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

### Overview

Databases may allow for large sets of data to be searched (or “queried”) and sorted based on the structure of the data within the database. To facilitate sorting (or “characterization”) of data within a database, the database may include one or more categories (or “records”). Each record within the database may include data with a common characteristic. For example, a database maintained by a corporation may include a record for each employee of the corporation, where each record includes data (documents, audio, etc.) associated with the employee.

Various types of representative data may be maintained in a database, such as text or media data, and media data may represent various forms of media, such as images, videos, audio, etc. Media data may include embedded information, such as information identifying a location, information indicating a time that the data was received or generated, information identifying the device that generated the data, etc.

Some methods to assign or characterize data (e.g., media data) to a portion (e.g., record) of a database may include multiple steps. Data may be received at the database, where the data may be unassigned at the time of upload to the database. Then, the received data may be assigned into a record of the database by an individual interacting with the database. For example, an individual, such as a database administrator, may select a portion (table, folder, entry, etc.) of the database for the received data to be assigned. Assigning the data to a selected portion of the database may include uploading the data to the portion of the database or otherwise linking the data to the portion of the database.

The method described above may be repeated upon receipt of new data. For example, a second set of data may be received, and the individual (administrator) may select a second portion of the database based on inspecting the second set of data.

However, upon receipt of multiple sets of data, the computing device may process and store the set(s) of data received until an indication is received on how to characterize each set of data. For example, some methods may initially store the set(s) of data on a computing device, wait for an indication from an individual on how to characterize one of the many sets of data, and upload that set of data into the identified portion of the database upon receipt of the indication. Storing many sets of data and processing multiple instructions to characterize data using some methods may exhaust computational resources (e.g., processor, memory, energy, etc.). As more uncharacterized media data are received at the computing device, the processing and memory resources may be exponentially exhausted in processing this data.

Further, of the multiple sets of data received, the sets of data may be assigned to different records within the database. Certain methods may include individual(s) inspecting each set of data received to identify what record of the database to associate with each set of data. Accordingly, computing device(s) may wait for an instruction of how to assign/sort each set of data before taking any action while storing the data unit receipt of this instruction. With a backlog of unassigned data, database efficiency may be reduced, as the computing device may be unable to identify data that is uncharacterized upon a query of the database. Further, with computational resources storing and processing uncharacterized data, database utilization and efficiency may be reduced.

Accordingly, techniques to automatically characterize media data and update a database are provided. A mobile field device (e.g., an unmanned aerial vehicle (UAV)) may transmit media data (e.g., an image of a city skyline) to a database server that accesses a database. The UAV (or “drone”) may move about a geographic region (e.g., California) and generate various media data (e.g., images). Upon generation of a media data, the UAV may embed metadata onto the media data that represents information about the UAV at the time of generating the media data.

A database server may receive a first media data (e.g., an image of a city skyline) from the UAV. The database server may identify characteristics of the media data from the first media data. Examples of media data characteristics may include identified objects, text, audio, etc. For example, with a first media data depicting an image of a skyline of a city, the database server may identify building(s) depicted in the first media data.

The database server may similarly identify metadata characteristics from the metadata included in the first media data. Examples of metadata can include orientation, geographic location, height, telemetry information, infrared/ultraviolet information, etc. For example, the first metadata characteristics may indicate that the UAV is located at a point within San Francisco at the time of generating the first media data.

With the media data characteristics and the metadata characteristics of the first media data identified, the database server may determine whether these characteristics match a classification (e.g., a known location, a known object, etc.) associated with a first record in a database. For example, the database server may determine that a building identified in the media data matches a known image of a building in San Francisco. The database server may determine a confidence of the match between the metadata characteristics and/or the media data characteristics with the classification.

If there is a match between the media data characteristics and/or the metadata characteristics with a classification, the first media data may be assigned (or “characterized”) to the first record. For example, if the database server identifies the first media data as depicting the San Francisco skyline, the database server may assign the first media data to a record corresponding to images of the San Francisco Skyline, a record corresponding to images of California, etc. Upon assigning a media data to a record in the database, the media data may be accessible and identifiable upon a query of the database for the media data or the record within the database.

The techniques as described above automatically characterize multiple media data based on the metadata embedded within the media data. A database server may identify characteristics of a media data based on the embedded metadata, such as location metadata identifying a geographic location. The computing device (e.g., a database server) can utilize the location metadata identifying a geographic location to characterize the media data with one of multiple records in a database.

Automatically characterizing multiple media data may increase computational efficiency, as media data may be characterized without instruction as to what record to characterize each media data. The efficiency of the database may be increased using the above-described techniques, as database server (s) do not have to store sets of uncharacterized data and process multiple instructions to characterize the data. The media data received may be associated/assigned with a record in the database, where the media data is characterized and identifiable upon a query of the record, thereby increasing accuracy and efficiency of database operations.

Embodiments may be described with reference to particular computer programs, system configurations, networks, etc. However, those skilled in the art will recognize that these features are equally applicable to other computer program types, system configurations, network types, etc. For example, although the term “application” may be used to describe a computer program, the relevant feature may be embodied in another type of computer program.

Moreover, the technology can be embodied using special-purpose hardware (e.g., circuitry), programmable circuitry appropriately programmed with software and/or firmware, or a combination of special-purpose hardware and programmable circuitry. Accordingly, embodiments may include a machine-readable medium having instructions that may be used to program a computing device to perform a process for characterizing multiple media data, updating records in a database, etc.

### Terminology

References in this description to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”). The terms “connected,” “coupled,” or any variant thereof is intended to include any connection or coupling between two or more elements, either direct or indirect. The coupling/connection can be physical, logical, or a combination thereof. For example, devices may be electrically or communicatively coupled to one another despite not sharing a physical connection.

The term “based on” is also to be construed in an inclusive sense rather than an exclusive or exhaustive sense. Thus, unless otherwise noted, the term “based on” is intended to mean “based at least in part on.”

The term “module” refers broadly to software components, hardware components, and/or firmware components. Modules are typically functional components that can generate useful data or other output(s) based on specified input(s). A module may be self-contained. A computer program may include one or more modules. Thus, a computer program may include multiple modules responsible for completing different tasks or a single module responsible for completing all tasks.

When used in reference to a list of multiple items, the word “or” is intended to cover all of the following interpretations: any of the items in the list, all of the items in the list, and any combination of items in the list.

The sequences of steps performed in any of the processes described here are exemplary. However, unless contrary to physical possibility, the steps may be performed in various sequences and combinations. For example, steps could be added to, or removed from, the processes described here. Similarly, steps could be replaced or reordered. Thus, descriptions of any processes are intended to be open-ended.

### Technology Overview

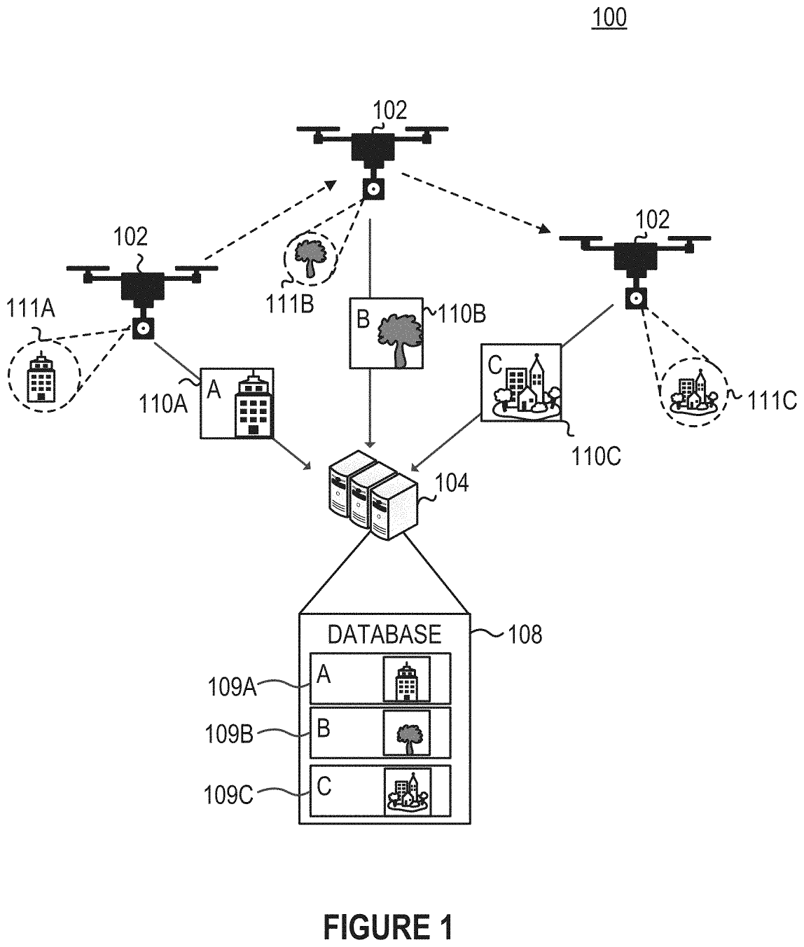

FIG. 1 illustrates a network environment 100, consistent with various embodiments. A field device 102 (shown as a unmanned aerial vehicle) may communicate with a database server 104 (shown as a series of interconnected servers). Particularly, the field device 102 may transmit multiple media data (e.g., images 110A-C) to the database server 104, and the database server 104 may associate (or “characterize”) the media data with a record within the database.

In the embodiment as shown in FIG. 1, the UAV 102 may move about a geographic region and generate media data across the geographic region. The UAV 102 may capture media (e.g., images 111A-C) and generate media data based on the captured media. For example, UAV 102 may capture an image of a building 111A in San Francisco and capture an image of a tree 111B in Los Angeles.

Field device 102 may include a network-capable device such as a personal computer, tablet computer, personal digital assistant (PDA), mobile phone, game console, music player, wearable electronic device (e.g., a watch or fitness accessory), network-connected (“smart”) electronic device, (e.g., a television or home assistant device), virtual/augmented reality system (e.g., a head-mounted display), or some other electronic device. In some embodiments, field device 102 may include an unmanned aerial vehicle (UAV), otherwise known as a “drone.”

Database server 104, meanwhile, may include a network-accessible computing device, such as a personal computer, server, or series of servers interconnected via a network, such as the internet. In some embodiments, the database server(s) 104 may maintain or access all or a portion of the database 108. The database server (s) may include portions of the database 108, where each database server is interconnected via a network, such as the internet, to transmit database information between database server(s). For example, in some embodiments, a first interconnected database server may maintain a listing of records in the database and links associated with each record. In this example, a second interconnected database server may maintain the media data associated with each link, where the first database server may receive the linked media data from the second database server.

As shown in FIG. 1, the database server 104 may maintain at least a portion of a database 108. Database 108 may include an organized collection of data, where the database 108 includes one or more records 109A-C. A record (e.g., record 109A) in the database 108 may include a classification (e.g., identifying a geographic range, such as a neighborhood, city, state, country, etc.). Each record 109A-C in the database may include a different classification or set of classifications.

As shown in FIG. 1, field device 102 may communicate with database server 104 via personal area networks (PANs), local area networks (LANs), wide area networks (WANs), metropolitan area networks (MANs), cellular networks, the Internet, etc. Additionally or alternatively, the field device 102 can connect to database server 104 over a wireless communication protocol, such as Wi-Fi, Bluetooth®, or Near Field Communication (NFC).

In some embodiments, the field device 102 may establish a connection with database server 104 upon authorization by the database server 104. The database server 104 may utilize an authorization technique (e.g., OAUTH2.0) to authorize the connection between field device 102 and database server 104. In some embodiments, the database server 104 or a device connected to the database server may transmit a security token to the field device 102 upon receipt of a request to connect from the field device 102. The security token may allow the field device 102 to establish a connection and to communicate with the database server.

As shown in FIG. 1, the field device 102 may transmit media data (e.g., images, videos, audio, etc.) 110A-C to the database server 104. For purposes of illustration, first media data 110A is indicative of an image of a building, second media data 110B is indicative of an image of a tree, and third media data 110C is indicative of an image of a town. Media data (e.g., 110A) may include embedded metadata, such as location information representative of a geographic location at the time of capturing the media data, timestamp information identifying a time when the media was captured, field device information identifying characteristic(s) of a field device, etc.

Upon receipt of the media data 110A-B, the database server 104 may characterize the media data 110A-B. In other words, the database server 104 may assign or link the received media data with a record within the database 108. As an example, an image of a building 110A may be received at the database server 104 and assigned with a first record 109A upon determining that the building depicted in the first media data matches a known image of that building. As another example, the image of the tree 110B may be assigned to a second record 209B based on identifying the species of tree (e.g., Oak) and matching the Oak tree with a known Oak tree associated with the second record 109B.

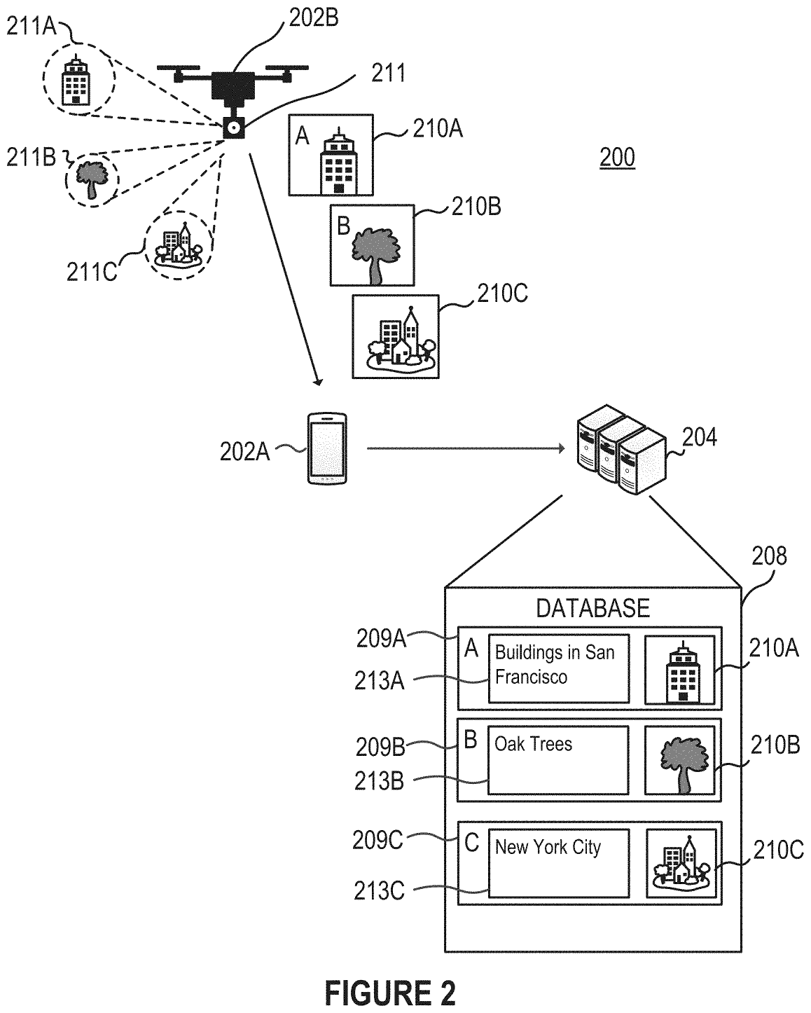

FIG. 2 illustrates a network environment 200 including multiple field devices 202A-B and a database server 204, consistent with various embodiments. As shown in FIG. 2, the first field device (mobile phone) 202A may communicate with a second field device (UAV or “drone”) 202B.

As shown in FIG. 2, a UAV 202B may capture multiple images 211A-C. The UAV 202B may move across a region (e.g., the San Francisco Bay area) and take a plurality of images in different locations around the region.

In some embodiments, the mobile phone 202A may control some or all components of the UAV 202B. For example, the UAV 202B may capture an image (e.g., image 211A) upon receipt of a communication from mobile phone 202A to capture the image. The UAV 202B may move about a region, continually generating media data 210A-C based on the images taken 211A-C, and maintain a specific height or orientation based on communication(s) received from the mobile phone 202A.

A field device (e.g., second field device 102B) may capture media data using a sensor, such as a camera, microphone, etc. However, it is contemplated that any field device (202A, 202B, etc.) may capture the media. For example, a sensor (camera 211) may capture a first image 211A, which represents a building. Similarly, the camera 211 may capture a second image 211B representing a tree, and a third image 211C representing a town. In some embodiments, multiple media (e.g., images 211A-C) may be captured by the camera 211 in all while located in various locations. For example, first image 211A may be captured in San Francisco, and the second image 211B may be captured in Palo Alto, and the third image 211C in San Jose. The captured media (e.g., images 211A-C) may be digitized into media data (e.g., 210A-C) to be transmitted to another device, such as mobile phone 202A, database server 204, etc.

Second field device 202B may transmit media data 210A-C to the first field device 202A. In some embodiments, the second field device 202B may embed location metadata into each media data 210A-C. In other embodiments, the first field device 202A may receive the media data 210A-C and embed location metadata onto the media data 210A-C. The embedded information/metadata may include information representing the characteristics of the field device 202A-B that captured the media data 210A-C.

In some embodiments, a field device 202A-B may include instructions to execute a computer program. In general, the routines executed to implement the embodiments of the disclosure may be implemented as part of an operating system or a specific application, component, program, object, module, or sequence of instructions (collectively referred to as “computer programs”). The computer programs may include one or more instructions set at various times in various memory and storage devices in a database server. When read and executed by the one or more processors, the instruction(s) cause the processing system to perform operations to execute elements involving the various aspects of the disclosure. In some embodiments, a field device 202A-B may communicate with a database server 204 via computer program.

As described above, the database server 204 may receive media data 210A-C. Upon receipt of a media data (e.g., first media data 210A), the database server 204 may determine whether the characteristics of the media data 210A match any classifications 213A-C associated with records 209A-C. For example, the database server 204 may determine first media data 210A to depict a building in downtown San Francisco. In this example, the classification 213A for the first record 209A includes buildings in San Francisco. Accordingly, upon determining that the first media data 210A matches a classification of a building in San Francisco, the first media data 210A may be assigned/characterized with the first record 209A.

In another example, a second media data 210B may be determined to depict an Oak tree based on comparing the media data with a known image of an Oak tree. Additionally, the second media data 210B may include characteristics about the state of the object depicted in the second media data 210B (e.g., whether the tree is ripe, whether the tree is diseased, etc.). The database server 204 may determine a state of the object by inspecting the characteristics of the media data 210B. The database server 204 may match the second media data 210B of an Oak tree with a classification of Oak trees 213B in the second record. Based on this determination, the second media data 210B may be associated with the second record 209B.

In some embodiments, media data (e.g., 210C) may include metadata characteristics and/or media data characteristics that does not match any classifications associated with any of the record(s) in the database 208. For example, the third media data 210C depicts an image of New York City, and no classifications 213A-B correspond with images of New York City. Accordingly, in this event, the database server 204 may generate a new record (e.g., 209C). Associated with new record 209C may include a new classification 213C that is indicative of the metadata and/or media data characteristics of the third media data 210C. For example, if the metadata characteristics indicate a geographic location for the third media data 210C to be New York City, the classification 213C for the new record 209C may include any characteristics relating to New York City.

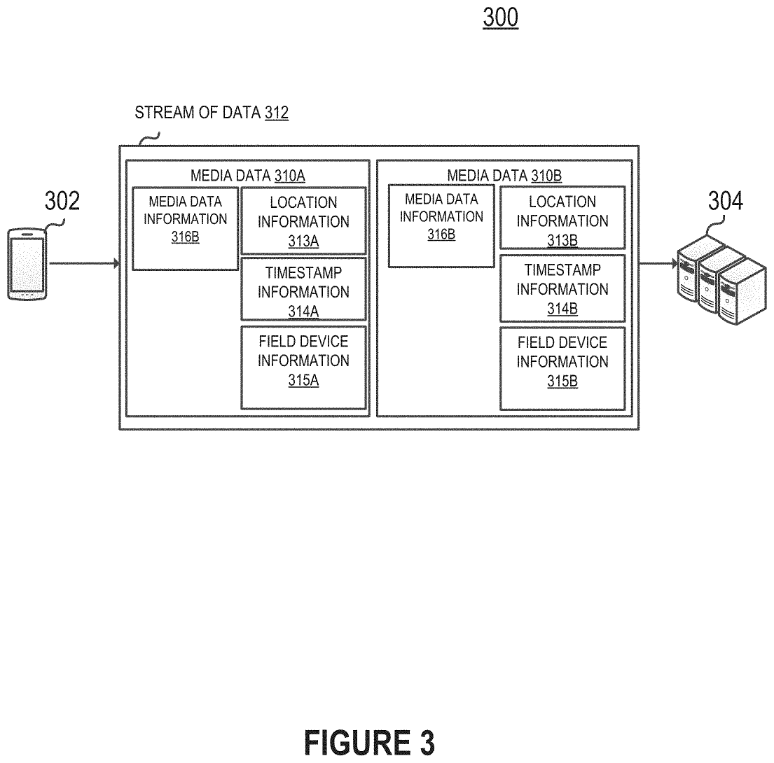

FIG. 3 depicts an illustration of media data transmitted by the field device 302 to the database server 304, consistent with various embodiments. As shown in FIG. 3, the field device 302 may transmit a stream of data 312 to the database server 304. The stream of data 312 may represent a stream of media data (e.g., media data 310A, 310B) transmitted over a time period. In some embodiments, the field device 302 may transmit all media data captured and/or received by the field device 302 (e.g., 310A-B) to the database server 304 over a predetermined time (e.g., one hour).

In some embodiments, the field device 302 may store the set of data 312 until the field device 302 establishes a connection with the database server 304. Upon establishing said connection, the field device 302 may transmit all data stored to the database server 304.

As shown in FIG. 3, the set of data 312 may include one or more media data 310A, 310B. As noted above, a media data (e.g., media data 310A, 310B) may represent captured/generated media, such as an image, video, audio, etc. Media data 310A-B may also include embedded data, such as location information (313A-B), timestamp information (314A-B), field device information (315A-B), etc. Other information, such as orientation characteristics or telemetry data of the field device 302 at the time of capture of the media data may be embedded into the media data.

Location information 313A-B may include information interpretable by the database server 304 to identify a geographic location. In some embodiments, the geographic location is the location of the field device 302 capturing the media (e.g., image) at the time of capturing said media. The location information may include cellular connectivity data (e.g., cell site location information (CSLI)), wherein the database server 304 may use a technique such as cellular triangulation to determine the geographic location. The location information 313A-B may also include space satellite connectivity data (e.g., global positioning system (GPS) information), where the database server 304 may interpret the GPS information to identify coordinates representing a geographic location. In other embodiments, the location information 313A-B may include an Internet Protocol (IP) address associated with a network, where the IP address may include geotagging data or metadata that may be inspected to determine the geographic location.

Timestamp information 314A-B may indicate the time upon which the media was captured. Timestamp information 314A-B may include data indicative of the date/time in which the media data was captured. In other words, when the media was captured (e.g., the image was taken), the timestamp information 314A-B may represent the time when the image was taken.

In some embodiments, the database server 304 may sort/order media data 310A-B based on the timestamp information 314A-B. In some embodiments, each media data 310A-B in a record (e.g., database 109A of FIG. 1) may be organized chronologically based on the timestamp information 314A-B. Such organization may increase database efficiency to query a record in the database to identify a media data within the record.

Media data 310A-B may include field device information 315A-B, where field device information 315A-B may include information identifying a field device (e.g., 302). Examples of field device information may include a serial number, MAC address, IP address of the field device, etc. Other examples of field device information 315A-B include characteristics of the field device 302 at the time of capturing media, such as direction, height, orientation data, telemetry data, etc. Database server 304 may inspect field device information 315A-B to identify a field device 302. In some embodiments, the field device information 315A-B may be utilized to identify one of a plurality of field devices transmitting sets of data to the database server 304.

In some embodiments, the location information embedded in a media data may identify the location captured in the media data. In other words, the database server 304 may identify the geographic location depicted in the media (e.g., image) based on location information and field device information. For example, media data 310A may include an image of the San Francisco skyline, but the image was captured by a field device facing San Francisco from an adjacent city, such as Oakland. In this example, the geographic location is the location captured in the media (i.e., San Francisco).

Identifying the location captured in the media may include identify characteristics of the field device, such as the height, direction, etc. of the field device. These characteristics may indicate the direction and potential geographic locations that were captured by the field device. The database server 304 may determine the geographic location here by inspecting the location of the field device at the time of the image capture (i.e. Oakland), and compare this with the field device characteristic data. In this example, if the location of the device is in Oakland, and the field device is facing West, the database server 304 may determine that the image in the media data depicts San Francisco. In some embodiments, the database server 304 may use image recognition techniques to identify objects in an image attributed to a geographic location.

In some embodiments, the database server 304 may project the geographic location of media data based on the telemetry of the field device 302. The field device 302 may be mobile, such as a UAV travelling in-air. In these events, the field device 302 may transmit telemetry data to the database server 304, either embedded in the media data or via a communication to the database server 304. Telemetry data may include orientation, speed, acceleration, height, etc., of the field device 302.

The database server 304 may determine the geographic location of the field device 302 at a given time based on the media data 310A-B received. Comparing this information with telemetry data, the database server 304 may determine a projected geographic location of the field device 302 at a later time. In some embodiments, the database server 304 may compare geographic information (e.g., GPS coordinates) against an external mapping service to determine any projected regions, landmarks, cities, etc. that the field device 302 may travel to based on prior telemetry data. Estimating the geographic location of future media data may reduce computational processes necessary to determine subsequent geographic locations the field device 302.

The media data 310A-B may include media data information 316A-B. media data information 316A-B may include information indicative of the media data. For example, the media data information 316A-B may represent pixels of an image. The database server 304 may identify and/or generate media (e.g., image) based on the media data information 316A-B. The media data information 316A-B may represent objects, such as a building in an image, for example. The database server 304 may identify an object in media data information 316A-B by comparing the object identified with a known object and determining whether the object matches the known object with a threshold confidence level.

In some embodiments, a record may include a log identifier (or “log link”). A log identifier may include a link or pointer that associates all media data received from a field device with a record. In other words, the log identifier 417 identifies the record and the field device (e.g., drone), where media data received by the identified field device may be automatically assigned to the identified record. The database may include multiple log identifier(s), where each log identifier associates a field device to a record.

In some embodiments, based on a log identifier associated with a field device, all media data received by that field device may be characterized and associated with the record that includes the log identifier. The database server may forward all received media data from a field device into the record (e.g., record 409A) with the log identifier. The log identifier may be identified by a network administrator or, in some embodiments, the log identifier may be identified based on receiving an input from the field device indicating the log identifier associated with the selected record.

In some embodiments, the media data (e.g., 310A) may represent an image of a receipt. A receipt may be characterized in a database to identify and maintain a listing of corporate expenses. A receipt may include information indicating the retail environment (restaurant, supply store, etc.), the location of the retail environment, the amount spent at the retail environment, and the date of the transaction. The database server 304 may utilize text detection and/or recognition techniques to identify text within the receipt. Based on the detected text, the database server 304 may identify a geographic location by inspecting the location identified in the receipt. The database server 304 may compare the identified location against an external mapping system or set of location points to determine a geographic location. Once a geographic location is identified, the database server 304 may associate the receipt with a record based on determining that the geographic location is within a threshold geographic range identified by a record.

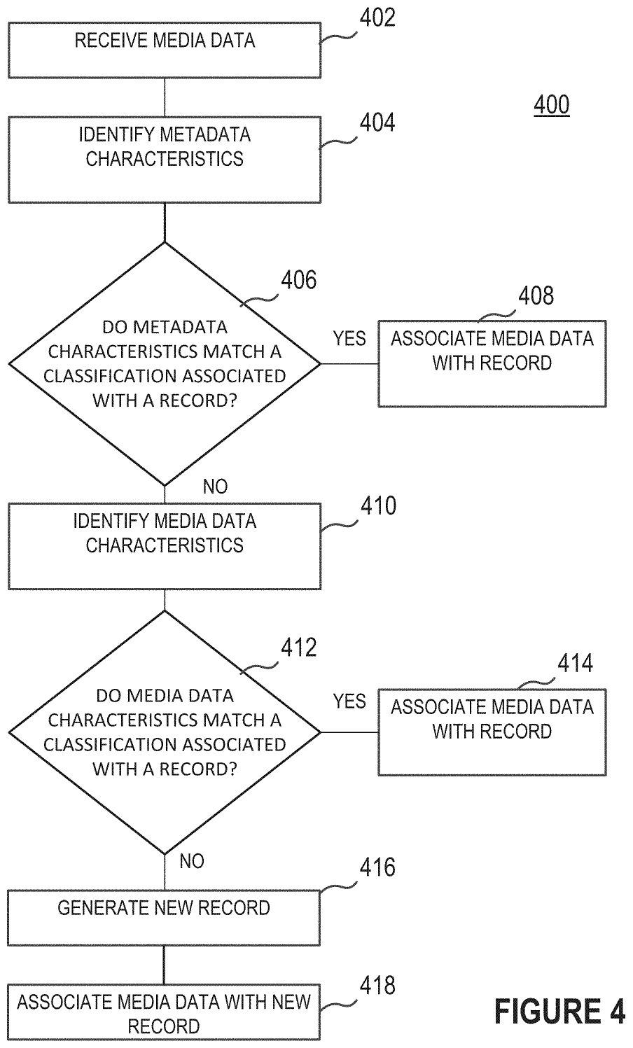

FIG. 4 depicts an illustration of a flow process 400 to characterize media data and update a database, consistent with various embodiments. As shown in FIG. 4, the database server may receive media data (block 402). The media data may include information relating to the media depicted in the media data, as well as metadata identifying information about the mobile field device at the time of generating the media data.

The database server may identify characteristics of the metadata embedded in the media data (block 404). Examples of metadata characteristics can include mobile field device orientation, height, telemetry information, etc. For example, the metadata characteristics may identify the location of a mobile field device at the time of generating a media data.

The database server may determine whether the metadata characteristics match a classification associated with a record (block 406). For example, a metadata characteristic may include a geographic location of San Francisco, and this location may match a classification identifying all locations within San Francisco. Matching the metadata characteristics with a classification may include determining similar aspects and features between the characteristics and classification.

If the metadata characteristics match a classification associated with a record, the media data is associated with that record (block 408). Such associating may include including a reference identifier (or “pointer) to the first media data that identifies the first record. For example, a pointer may link (or associate) media data with record, where the database server can retrieve the media data with the pointer upon a query of record. The reference identifier may include a link associated with a record, where upon a query for the media data at a record, the database may identify the media data using the reference identifier.

The database server may identify characteristics of the media data embedded in the media data (block 410). Examples of media data characteristics can include objects, text, characters, audio, etc. For example, the media data characteristics may identify a building, such as the United States Capitol Building, for example.

The database server may determine whether the media data characteristics match a classification associated with a record (block 406). For example, a media data characteristic may include the United States Capitol Building, and this characteristic matches a classification that includes a known depiction of the United States Capitol Building.

If the media data characteristics match a classification associated with a record, the media data is associated with that record (block 414). Such associating may include including a reference identifier (or “pointer) to the first media data that identifies the first record.

If the database server determines that the media data characteristics and/or the metadata characteristics identified in the media data do not match any classifications of any records, the database server may generate a new record (block 416). For example, if the geographic location of the media data is determined to include Los Angeles, and no classification includes Los Angeles, the new record may include a classification that includes Los Angeles.

The database server may associate the media data with the new record using techniques as described herein (block 418).

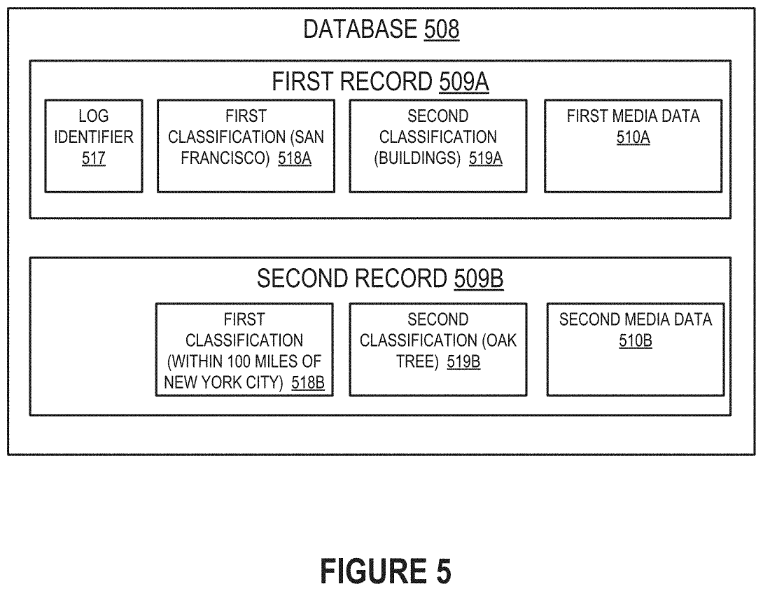

FIG. 5 depicts an illustration of a database 508, consistent with various embodiments. The database 508 may store and/or access a collection of data and the collection of data may be divided into records (e.g., first record 509A, second record 509B).

As shown in FIG. 5, a record (e.g., 509A) may include a log identifier (or “log link”) 517. A log identifier 517 may include a link or pointer that associates all media data received from an electronic device with a record. In other words, the log identifier 517 identifies the record upon which all media data received by an electronic device is to be characterized. The database 508 may include multiple log identifier(s), where each log identifier 517 associates an electronic device to a record.

In some embodiments, based on a log identifier 517 associated with an electronic device, all media data received by that electronic device may be characterized and associated with the record that includes the log identifier 517. The computing device may forward all received media data from an electronic device into the record (e.g., record 509A) with the log identifier 517. The log identifier 517 may be identified by a network administrator or, in some embodiments, the log identifier may be identified based on receiving an input from the electronic device indicating the log identifier 517 associated with the selected record.

A record (e.g., first record 509A) may include a first classification 518A. A classification 518A-B may include a characteristic or feature of media data that is common among the data stored in a record. To illustrate, a first record 509A may include a first classification 518A that includes all media data that was generated within the city limits of San Francisco. In this illustration, if metadata embedded in a first media data 510A includes a location within San Francisco, the first media data 510A may be associated with the first record 509A. Accordingly, the first record 509A may include a plurality of media data (images, songs, videos, etc.) that all match or are connected to a first classification 518A.

In some embodiments, a second record 509B may include a first classification 518B different than a first classification 518A of a first record 509A. For example, a second classification 518B of a second record 509B may include media data with a geographic location that is within 100 miles within a reference point in New York City. If the media data characteristics match this classification, the media data may be assigned to the second record 509B.

A record (e.g., first record 509A) may include a second classification 519A. A second classification 519A-B may be a second identifying aspect of the media data. In an embodiment, the first classification 518A-B relates to metadata characteristics (e.g., geographic location, orientation, etc.) of a media data, and a second classification 519A-B relates to media data characteristics (e.g., objects, text, etc.) of the media data. For example, a second classification for a first record 519A may include buildings. Here, the second classification 519A may include known images of buildings, and any objects in the media data may be compared with the known images to determine whether it is a building.

In another example, a second classification 519B may include all oak trees identified in media data. The database server can identify an object in media data by detecting features of the object and comparing the features with known images. In an embodiment, the object in media data may be identified both as a tree and also as an oak tree based on known images and features of an oak tree.

In an embodiment, the characteristics of the media data may be inspected to determine a status of an object in the media data. For example, the database server may identify whether an oak tree is dead, or the database server can identify whether a corn stalk is ripe for harvest. This status may be determined using characteristics of the media data, such as image characteristics, ultraviolet/infrared sensing, sensor information, etc.

As an example, for purposes of illustration, record 509B has a geographic location 518B that includes all points within a 100-mile radius of reference point A. Upon receipt of a predetermined number of media data, the computing device may iteratively decrease the range of the geographic location from a 100-mile radius to a 90-mile radius. Similarly, the iterative modification of the threshold geographic range may replace a state-wide radius range (California) to a city-wide radius range (San Francisco). Such iterative modifications to the threshold geographic range may increase accuracy in characterizing the media data received.

The media data (e.g., first media data 510A) may be associated with a record (e.g., first record 509A). The media data may be associated based on the characteristics of the media data (e.g., location, identified objects, timestamp, etc.) matching the first and/or second classifications 518A-B, 519A-B identified by a record 509A-B. In some embodiments, the media data may be associated with a record based on both a first classification and a second classification matching the media data characteristics.

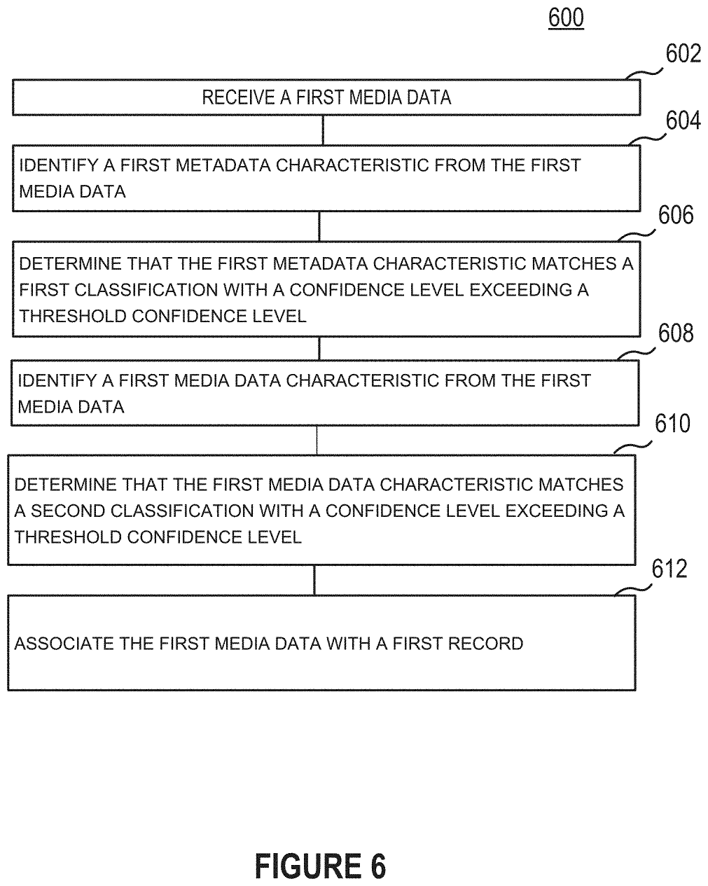

FIG. 6 depicts a block diagram 600 illustrating a method to update a database, consistent with various embodiments. A computing device may receive a first media data from a mobile field device (block 602). The first media data may part of a stream of data transmitted by the mobile field device moving about a region.

The computing device may identify a first metadata characteristic based on metadata embedded in the first media data (block 604). Metadata characteristics may include information relating to the mobile field device at a time of generating the first media data. For example, a first metadata characteristic may include a geographic location (e.g., San Francisco, a reference point, etc.).

In some embodiments, the metadata characteristics of the first media data can identify a location depicted in the first media data. In other words, the location depicted in an image may be identified based on metadata characteristics. The computing device can identify orientation and height characteristics of the mobile field device. For example, if the mobile field device has metadata characteristics showing that the device is in Oakland, California at the time of generating the first media data, and is facing west at a height of200 feet, the computing device can determine that the image depicted in the first media data depicts San Francisco.

The computing device may determine that the first metadata characteristic matches a first classification with a confidence level exceeding a threshold confidence level (block 606). For example, a metadata characteristic indicates the location of the mobile field device at the time of generating the first media data to be at Central Park in New York City. In this example, if a first classification indicates all geographic locations within New York City, the computing device can determine that the geographic location (Central Park) is within the limits of New York City, thereby matching with a high confidence level.

A confidence level may be an indication of the confidence of the match between the first metadata characteristic and the classification. A confidence level may be assigned based on the number of similarities identified between the characteristic and the classification. Based on this, a threshold confidence level may include a minimum number of similarities between the characteristic and the classification.

In some embodiments, the classification(s) may be modified based on an iteration of media data received. In other words, a classification identified by each record may modify upon receipt of a number of media data. Each time a media data is received, the database server may determine whether to modify the classification. The amount of modification of the classification upon each iteration may be based on the total computational capacity of the database server (s) or upon the overall number of media data received over a time period.

As an example, for purposes of illustration, a record includes a classification including all points within a 100-mile radius of reference point A. Similarly, a second record includes a second classification including all points within a 100-mile radius of reference point B. In this example, a first media data is associated with the first record. Upon receipt of a second media data, the database server may iteratively decrease the distance of each classification from a 100-mile radius to a 90-mile radius. Similarly, the iterations of the classification may replace a state-wide radius range (California) to a city-wide radius range (San Francisco). Such iterative modifications to the classification may increase accuracy in characterizing the media data received.

The computing device may identify a first media data characteristic from the first media data (block 608). Examples of media data characteristics may include object(s) (e.g., a building, an individual's face, etc.) in an image, an aspect (e.g., a voice, a tune, a word, a song, etc.) in audio, etc.

The computing device may determine that the first media data characteristic matches a second classification with a confidence level exceeding a threshold confidence level (block 610). For example, the first media data characteristic may include an identified object of a building. Further, the second classification may include a known image of the United States Capitol Building in Washington, D.C. The computing device may compare the identified object of the building with the known image to determine that the images match and that the identified object of the building is an image of the United States Capitol Building. In some embodiments, the computing device can identify metadata characteristics (a geographic location) based on matching an object with a known object. For example, matching an object with the United States Capitol Building may identify a geographic location as being within Washington, D.C.

In another example, the computing device may identify text within an image. The text may indicate an individual, a geographic location, a timestamp, etc. For example, the image may be of a receipt, where the receipt has text indicating an individual that received the receipt, a business that gave the receipt, a location of the business, a date of the transaction, etc. In this example, the computing device may determine if the individual is approved to transmit the receipt by authenticating the individual and/or location as being approved. For example, if individual A is authorized to purchase a meal for a potential client in the city of Chicago, the computing device can authorize the individual based on identifying the individual and the location of the receipt (e.g., Chicago) from the receipt. Based on such approval, the receipt may be associated with a record with a classification identifying the individual or the potential client.

The confidence level may include the number of similar features between the characteristic and the second classification. Using the example illustrated above, the confidence level may be determined by identifying all similar points/features of the identified object and the known image. The threshold confidence level may include the minimum number of similarities to infer that the identified characteristic matches and is the same as the item in the second classification.

A threshold confidence level may include a minimum confidence level that is indicative that the characteristic matches the classification. In other words, the threshold confidence level is a level of similarity between the characteristic and the classification that implies that the characteristic matches the classification. For example, if a media data characteristic is an object, the classification may include a known object. Based on comparing the similarity between the object and the known object, a confidence level may be determined. For example, the confidence level may be 85%. If the threshold confidence level is set at 70%, the confidence level is great enough and the object matches the known object of the classification.

The computing device may associate the first media data with a first record (block 612). Associating the first media data with the first record may include modifying the first media data to include a header or other indicating data that identifies the first record as part of the first media data. In other embodiments, the first media data may be stored in a portion of the database that is associated with the first record. The first media data may be identified or accessible upon a query of the first record after the first media data is associated with the first record.

### Processing System

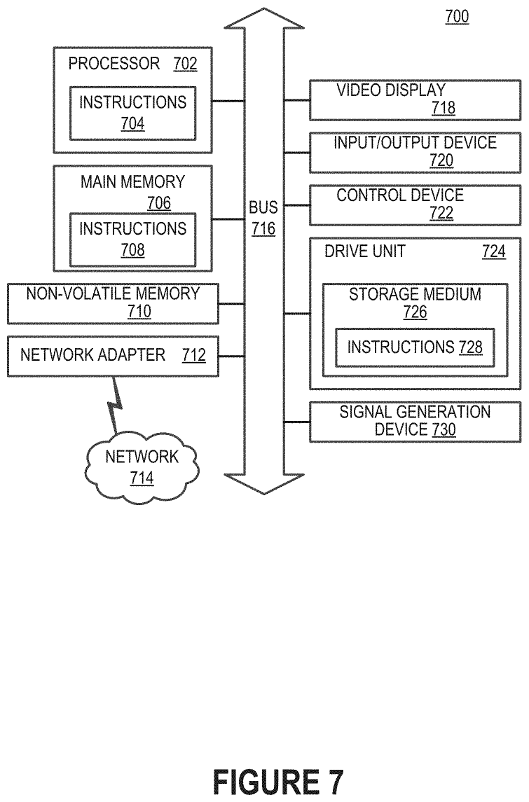

FIG. 7 is a block diagram illustrating an example of a processing system 700 in which at least some operations described herein can be implemented. For example, some components of the processing system 700 may be hosted on a computing device that includes a database (e.g., database server 104 of FIG. 1). As another example, some components of the processing system 700 may be hosted on a field device (e.g., field device 102 of FIG. 1).

The processing system 700 may include one or more central processing units (“processors”) 702, main memory 706, non-volatile memory 710, network adapter 712 (e.g., network interface), video display 718, input/output devices 720, control device 722 (e.g., keyboard and pointing devices), drive unit 724 including a storage medium 726, and signal generation device 730 that are communicatively connected to a bus 716. The bus 716 is illustrated as an abstraction that represents one or more physical buses and/or point-to-point connections that are connected by appropriate bridges, adapters, or controllers. The bus 716, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The processing system 700 may share a similar computer processor architecture as that of a desktop computer, tablet computer, personal digital assistant (PDA), mobile phone, game console, music player, wearable field device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 700.

While the main memory 706, non-volatile memory 710, and storage medium 726 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 728. The term “machine-readable medium” and “storage medium” shall also be taken to include any medium that is capable of storing, encoding, or carrying a set of instructions for execution by the processing system 700.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in a computing device. When read and executed by the one or more processors 702, the instruction(s) cause the processing system 700 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 710, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 712 enables the processing system 700 to mediate data in a network 714 with an entity that is external to the processing system 700 through any communication protocol supported by the processing system 700 and the external entity. The network adapter 712 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 712 may include a firewall that governs and/or manages permission to access/proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A computer-implemented method for updating a database, the method comprising:
receiving a stream of data from a mobile field device;
identifying a first media data from the stream of data;
inspecting metadata included with the first media data to identify first metadata characteristics representing information relating to the mobile field device at a time of generating the first media data;
determining, by a processor, that the first metadata characteristics match a first classification identified by a first record in a database with a metadata confidence level that exceeds a threshold metadata confidence level;
inspecting the first media data to identify first media data characteristics indicating features of the first media data;
determining, by the processor, that the first media data characteristics match a second classification identified by the first record in the database with a media data confidence level that exceeds a threshold media data confidence level; and
associating the first media data to the first record based on at least one of the first metadata characteristics matching the first classification and the first media data characteristics matching the second classification.

2. The computer-implemented method of claim 1,
wherein the first media data characteristics identify a first object,
wherein the second classification identified by the first record includes a known object, and
wherein said determining that the first media data characteristics match the second classification further includes matching the first object with the known object.

3. The computer-implemented method of claim 2, further comprising:
determining a geographic location of the first media data based on a known geographic location associated with the known object matching the first object.

4. The computer-implemented method of claim 1, further comprising:
identifying a first geographic location based on the first metadata characteristics, wherein the first geographic location includes a geographic location of the mobile field device at the time of generating the first media data.

5. The computer-implemented method of claim 4, further comprising:
determining, by the processor, that the first geographic location is within a first threshold geographic range indicated by the first record of the database; and
associating the first media data to the first record of the database based on determining that the first geographic location is within the first threshold geographic range.

6. The computer-implemented method of claim 5, further comprising:
receiving a second media data;
inspecting metadata of the second media data to identify a second geographic location of the mobile field device at a time of generating the second media data;
determining, by the processor, that the second geographic location is beyond the first threshold geographic range indicated by the first record;
determining, by the processor, that the second geographic location is within a second threshold geographic range indicated by a second record of the database, based on determining that the second geographic location is beyond the first threshold geographic range; and
associating the second media data to the second record based on determining that the second geographic location is within the second threshold geographic range.

7. The computer-implemented method of claim 1, further including:
receiving a third media data;
identifying third metadata characteristics by inspecting metadata included in the third media data;
determining, by a processor, that the third metadata characteristics do not match any classifications identified by any record in the database with a third metadata confidence level that exceeds the threshold confidence level;
inspecting the third media data to identify third media data characteristics;
determining, by the processor, that the third media data characteristics does not match any classifications identified by the records in the database with a third media data confidence level that exceeds the threshold confidence level;
generating a new record, where a classification of the new record includes the third metadata characteristics and the third media data characteristics; and
associating the third media data to the new record.

8. The computer-implemented method of claim 1, wherein the mobile field device includes an unmanned aerial vehicle (UAV),
wherein the UAV is configured to generate a plurality of media data across various geographic locations, and
wherein the UAV is configured to embed metadata to the first media data based on characteristics of the UAV at the time of generating the first media data.

9. The computer-implemented method of claim 1, further comprising:
receiving a fourth media data from the mobile field device;
identifying a log identifier included within a fourth record of the database, wherein the log identifier identifies the mobile field device; and
associating the fourth media data to the fourth record based on the log identifier identifying the mobile field device.

10. The computer-implemented method of claim 1, further comprising:
determining text based on characters included within the first media data characteristics;
identifying an individual and a geographic location based on the determined text;
determining that the individual is approved to transmit the first media data based on authenticating the individual and the geographic location identified in the first media data; and
associating the first media data with the first record that identifies the individual based on authenticating the individual and the geographic location identified in the first media data.

11. The computer-implemented method of claim 1, wherein the media data confidence level is determined by comparing the first media data characteristics and the second classification, and wherein the threshold media data confidence level represents the minimum amount of the first media data characteristics that match the second classification.

12. A computing device, comprising:
a memory that includes instructions for updating a database,
wherein the instructions, when executed by a processor, cause the processor to:
receive a first media data;
inspect metadata included with the first media data to identify first metadata characteristics;
inspect the media data to identify first media data characteristics;
determine that at least one of the first metadata characteristics and the first media data characteristics match a classification characteristic identified by a first record in a database with a confidence level exceeding a threshold confidence level; and
associate the first media data to the first record based on at least one of the metadata characteristics and the media data characteristics of the first media data matching the classification characteristic.

13. The computing device of 12, further causing the processor to:
compare a first object identified in the first media data characteristics with a known object identified in the classification characteristic; and
determine that the first object matches the known object with the confidence level exceeding the threshold confidence level by determining similar features of each of the first object and the known object.

14. The computing device of 12, further causing the processor to:
identify a first geographic location of the first media data based on an orientation characteristic and a mobile field device geographic location identified in the first metadata characteristics, wherein the first geographic location of the first media data identifies a location depicted in the first media data.

15. The computing device of 12, further causing the processor to:
identify a first geographic location of a mobile field device at a time of generating the first media data by inspecting the first metadata characteristics;
determine that the first geographic location is within a first threshold geographic range indicated by the first record of the database; and
associate the first media data to the first record of the database based on determining that the first geographic location is within the first threshold geographic range.

16. The computing device of 15, further causing the processor to:
receive a second media data;
inspect metadata of the second media data to identify a second geographic location of the mobile field device at a time of generating the second media data;
determine that the second geographic location is beyond the first threshold geographic range indicated by the first record;
determine that the second geographic location is within a second threshold geographic range indicated by a second record of the database; and
associate the second media data to the second record based on determining that the second geographic location is within the second threshold geographic range.

17. The computing device of 12, further causing the processor to:
receive a third media data;
identify third metadata characteristics by inspecting metadata included in the third media data;
determine that the third metadata characteristics do not match any classification characteristics identified by any record in the database with the confidence level exceeding the threshold confidence level;
inspect the third media data to identify third media data characteristics;
determine by the processor, that the third media data characteristics does not match any classifications characteristics do not match any classification characteristics identified by any record in the database with the confidence level exceeding the threshold confidence level;
generate a new record, where a classification characteristic of the new record includes the third metadata characteristics and the third media data characteristics; and
associate the third media data to the new record.

18. The computing device of claim 12, further causing the processor to:
receive a fourth media data from the mobile field device;
identify a log identifier included within a fourth record of the database, wherein the log identifier identifies the mobile field device; and
associate the fourth media data to the fourth record based on the log identifier identifying the mobile field device.

19. A method performed by a computing device to update a database, the method comprising:
receiving a first media data;
inspecting metadata included with the first media data to identify first metadata characteristics identifying information relating to a mobile field device at a time of generating the first media data;
determining, by a processor, that the first metadata characteristics match a first classification identified by a first record in a database with a metadata confidence level that exceeds a threshold metadata confidence level;
inspecting the first media data to identify first media data characteristics indicating features of the media data;
determining, by the processor, that the first media data characteristics match a second classification identified by the first record in the database with a media data confidence level that exceeds a threshold media data confidence level; and
associating the first media data to the first record based on at least one of the first metadata characteristics matching the first classification and the first media data characteristics matching the second classification.

20. The computer-implemented method of claim 19, wherein the first first metadata characteristics includes a first geographic location of the mobile field device at the time of generating the first media data,
wherein the first classification includes a geographic range that includes the first geographic location,
wherein the first media data characteristic is an identified object, and
wherein the second classification is a known object matching the identified object with the media data confidence level exceeding the threshold media data confidence level.
